(19) United States
(12) Patent Application Publication
(10) Pub. No.: US 2019/0390844 A1
(43) Pub. Date: Dec. 26, 2019

(54) LED Headlamp with Multiple Power Input Capability

(71) Applicant: Optimal Ventures, LLC, Arlington Heights, IL (US)

(72) Inventors: Walter J. Sedlacek, West Chicago, IL (US); Daniel J. Williams, Wood Dale, IL (US); Christopher Yunkun, Prospect Heights, IL (US); Patrick J. McVey, Wheeling, IL (US); Aleksander Poniatowski, Wheeling, IL (US); Brian Andrew Donlin, Chicago, IL (US); Rodrigo Flores, Elgin, IL (US)

(21) Appl. No.: 16/448,443

(22) Filed: Jun. 21, 2019

Related U.S. Application Data
(60) Provisional application No. 62/688,866, filed on Jun. 22, 2018.

(51) Int. Cl. F21V 21/084; F21L 4/00; F21V 15/01; F21V 23/06

(52) U.S. Cl. CPC F21V 21/084; F21L 4/00; F21Y 2115/10; F21V 23/06; F21V 15/01

(57) ABSTRACT

An LED headlamp for attachment directly or indirectly to a user. Generally speaking, the disclosed headlamp includes an adjustable strap for securing to a user (e.g., head, arm, jacket, backpack, etc.), an LED array detachably securable to the adjustable strap, and a battery pack coupled to the LED array via an input power port. Preferably, the battery pack is rechargeable and is hardwired to the LED array. Optionally, the array may include a connection port that can accept any of several different power sources for powering the LED array of the headlamp, including a DC battery pack (e.g., AAA, AA batteries), a portable charger, an AC connection, to a wall outlet, and a computer USB charging connection. Further, the LED array may include a range of from 4 to 30 LEDs; more preferably, the number of LEDs is in the range of from 8 to 20. The LEDs should be spaced to provide a broadband of illumination, as opposed to a focused beam. The resulting illumination arc is at least 120 degrees, preferably at least 180 degrees, and most preferably about 210 degrees.

### RELATED APPLICATION

This application claims the filing priority of U.S. Provisional Application No. 62/688,866 filed on Jun. 22, 2018 and titled “LED Headlamp With Multiple Power Input Capability.” The '866 application is hereby incorporated by reference.

### TECHNICAL FIELD OF THE INVENTION

The present invention relates to wearable headlamps. Specifically, the disclosed invention relates to an LED headlamp which provides a broad illuminating arc of light instead of a narrow conical beam of light.

### BACKGROUND OF THE INVENTION

For people who like to go camping, hiking, backpacking, climbing, mountain biking, trail running, or nearly anything else in the outdoors, and for those who like to tackle the occasional do-it-yourself project, home repairs, and the like, a wearable headlamp is a valuable, if not necessary piece of equipment. Replacing the handheld flashlight as a ready source of illumination, the headlamp is a very handy piece of technology which has seen impressive leaps over the past few years. The industry has increased maximum light output (rated in lumens), battery options, water-resistance, and many other features which have benefitted users.

However, improving features such as fit, comfort, adaptability, power source, battery-life and beam size have been largely ignored. Until the invention of the present application, these and other problems in the prior art went either unnoticed or unsolved by those skilled in the art. The present invention provides an improved headlamp which outperforms prior art devices without sacrificing portability features, designs, style or affordability.

### SUMMARY OF THE INVENTION

There is disclosed herein an improved headlamp which avoids the disadvantages of prior devices while affording additional structural and operating advantages.

Generally speaking, the disclosed headlamp comprises an adjustable strap for securing to a user, an LED array detachably securable to the adjustable strap, and a battery pack coupled to the LED array via a connection port.

In specific embodiments, the battery pack comprises a rechargeable battery (or batteries). Multiple input power sources may be coupled to the LED array through the connection port.

In preferred embodiments, the charging port can accept any of several different power sources including a DC battery pack (e.g., AAA, AA batteries), AC from a wall outlet, and a computer USB charging connection.

In preferred embodiments, the LED array comprises a range of from 4 to 30 LEDs. More preferably, the number of LEDs is in the range of from 8 to 20. The LEDs should be spaced so as to provide a broadband of illumination, as opposed to a focused beam.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of a first embodiment of the disclosed wearable LED headlamp;

FIG. 2 is a right-side plan view of a second embodiment of the disclosed wearable LED headlamp;

FIG. 3 is a left-side plan view of the embodiment of FIG. 2;

FIG. 4 is a graphic representation of a prior art illumination cone vs. an illumination arc of the disclosed LED headlamp;

FIG. 5 illustrates an embodiment of the disclosed headlamp being worn directly on a user's head;

FIG. 6 illustrates an embodiment of the disclosed headlamp being worn on a user's hat;

FIG. 7 is a front perspective view of the headlamp shown in FIG. 2;

FIG. 8 is a close-up view of an embodiment of headband connectors for connecting to the LED array;

FIG. 9 is a top view of an embodiment of a disassembled headlamp with a small battery back and a large battery pack;

FIG. 10 is a close-up view of an embodiment of a power switch used to change the power level of the LED array;

FIG. 11 is a close-up view of an embodiment of a power source for the headlamp shown in FIG. 2;

FIGS. 12A-C are illustrations of an embodiment of a rechargeable battery pack, including (A) configured for powering the LED array, (B) removal of power cord from battery pack, and (C) attachment of power cord to charging port;

FIG. 13 is a top view showing an embodiment of an LED array with a small battery pack and a large battery pack;

FIG. 14 is a perspective view of an embodiment of the disclosed headlamp connected to a large battery pack;

FIG. 15 is a perspective view of an embodiment of the disclosed headlamp connected to a thumb-drive charger; and

FIG. 16 is a perspective view of an embodiment of the disclosed headlamp connected to an AC power cord.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

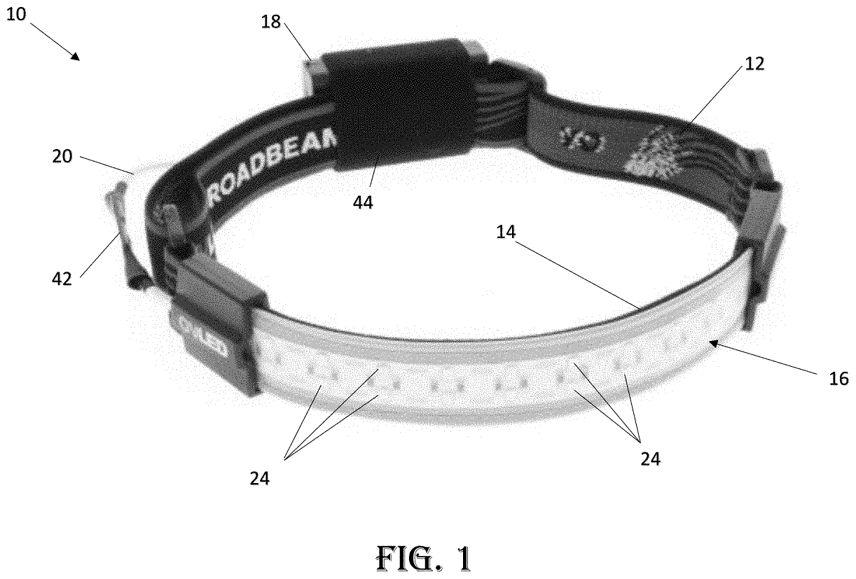

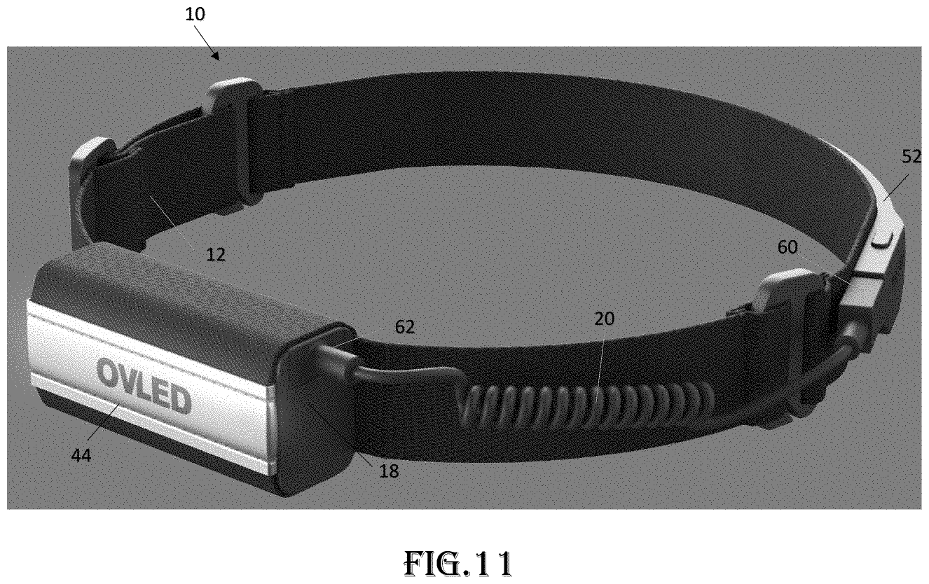

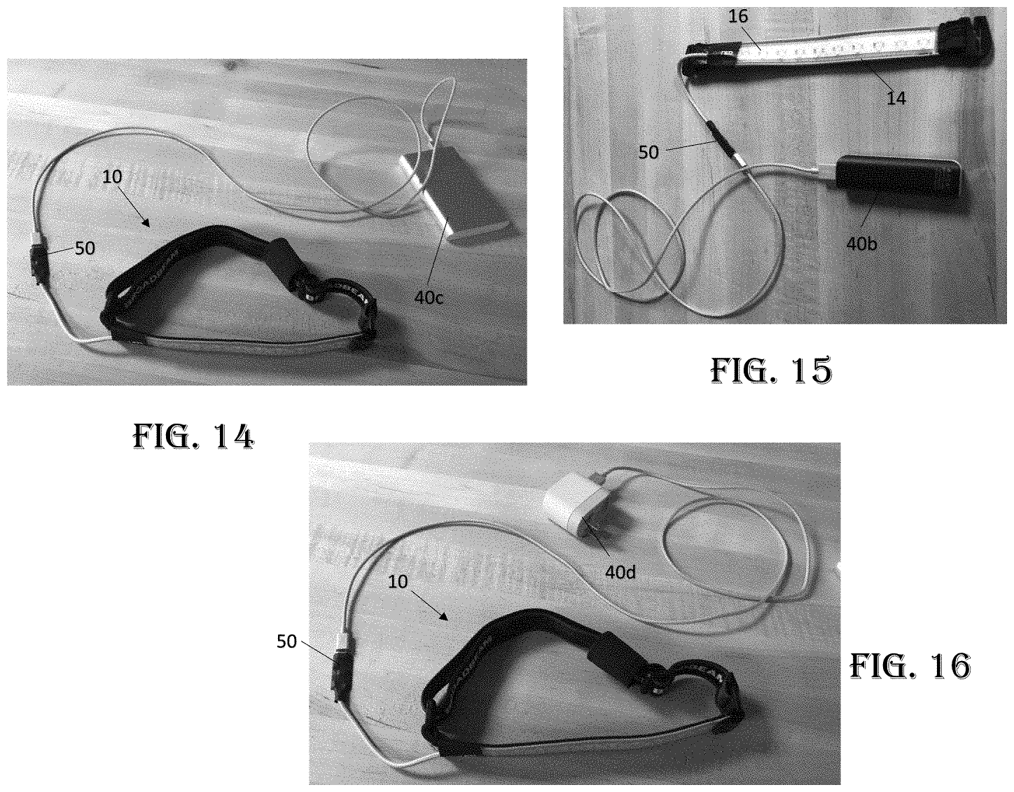

Referring to FIGS. 1-16, there are illustrated embodiments of a headlamp, generally designated by the numeral 10. The particular illustrated headlamp 10 is designed to be worn on the head of a user. However; the use of an adjustable band 12 allows attachment to other areas and, as will be described, the illuminating source (i.e., LED array strip 14) may be detached from the adjustable band portion 12 and affixed to other body parts or, alternatively, to user equipment, such as a backpack for example.

As can be seen in the embodiments of FIGS. 1-3, the headlamp 10 is comprised of a flexible adjustable strap portion 12, an LED array 16 attached to a second flexible strap 14, and a battery pack 18 connected by an electric wire/cord 20 to the LED array 16. The adjustable strap portion 12 is preferably a soft, flexible-elastic strap with adjustability to allow for a comfortable and secure, fit to most head sizes. The second flexible strap 14 is comprised of a flexible material as well and is stitched (or adhered in any suitable manner) to the LED array 16. At each end of the second flexible strap 14 is a connector 22.

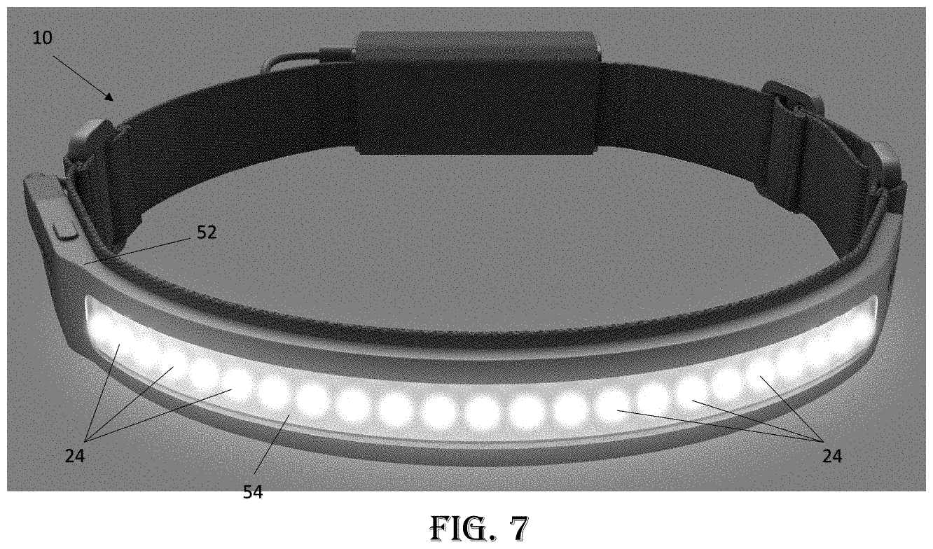

A plurality of LEDs 24 are positioned on a strip to form the LED array 16. As shown in FIG. 1, 20 LEDs 24 are used for a preferred embodiment. High-Efficiency LEDs are most preferred and can be positioned in a 2×10 (10 sets of 2 LEDs) broadband fashion to provide a wide arc 30 of illuminating light. However, a single line of closely positioned LEDs 24 may also be effective (see FIG. 7).

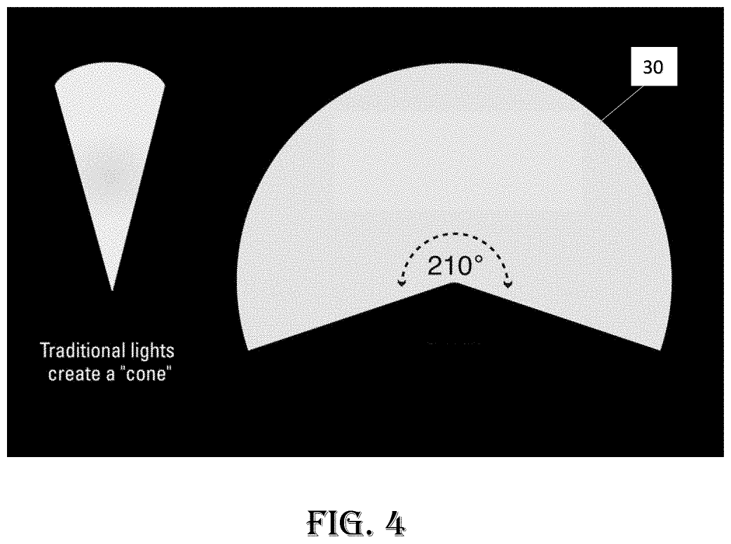

As illustrated in FIG. 4, these configurations of LEDs 24 allow projection of an illuminating arc 30 not just directly forward like all prior art headlamps, but also provides light coverage for peripheral views. It has been found that illuminating arcs 30 of at least 120 degrees, at least 180 degrees and even of 210 degrees are achievable. As many as 30 LEDs and as few as 4 LEDs may be used in the array 16 for most practical applications. Preferably, somewhere in the range of 8 to 20 LEDs would be used for an optimal illuminating arc. A target light output of about 300 lumens has been found to provide sufficient and significant illumination.

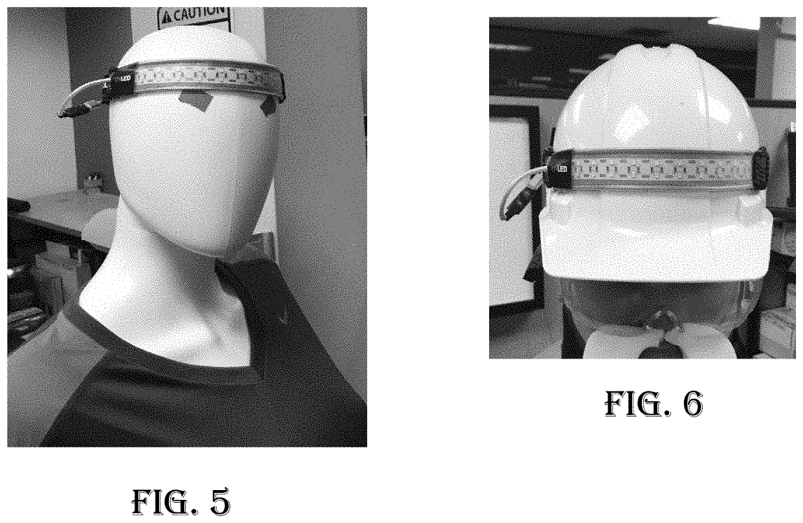

The disclosed LED headlamp 10 is specifically intended to be worn as shown in FIGS. 5 and 6. That is, a user can adjust the strap portion 12 for wearing directly on the user's head (FIG. 5), much like a sweatband, or it can be made larger for placement over a hat or helmet (FIG. 6). In the preferred embodiments, the elasticity of the two band sections, 12 and 14, ensures a secure grip without being too tight.

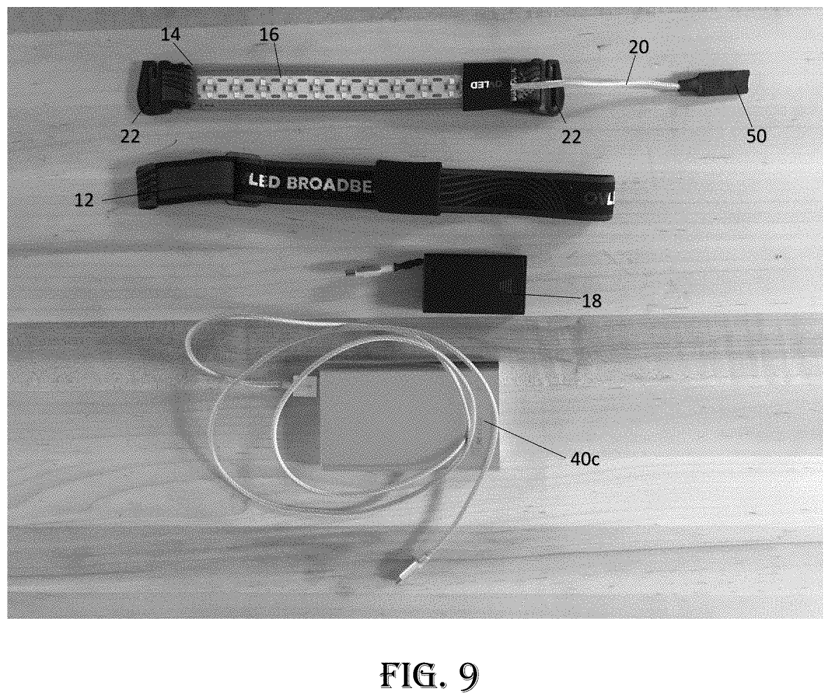

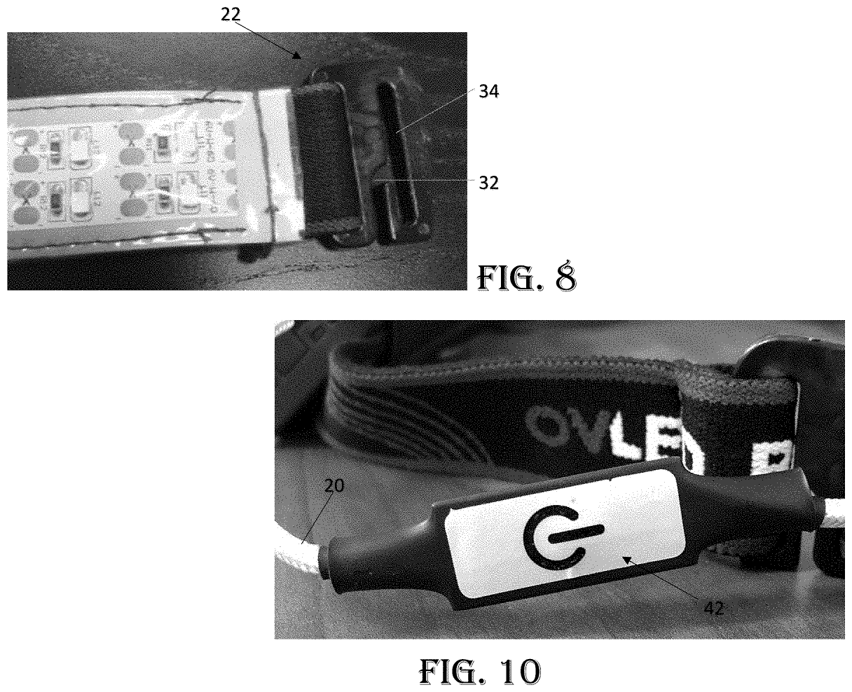

Referring to FIGS. 8 and 9, the connectors 22 are used on each end of the second strap 14 to connect and disconnect the LED array 16 to and from the adjustable strap portion 12. The unique lightweight connectors 22 illustrated are used to allow the second strap 14 with the LED array 16 to be readily attached and detached from the adjustable strap 12, while preventing any accidental detachment. The preferred connectors 22 have a short, curved insertion channel 32 which leads to central area of a retention slot 34 for securing the adjustable strap 12. Once positioned within the retention slot 34, the adjustable strap portion 12 is prevented from slipping out of the insertion channel 32 because of the positioning. However, a user may easily manipulate the adjustable strap portion 12 to remove it from the slot 34 through the channel 32. Alternatively, other connectors known and widely used in the art may be substituted provided they cannot be easily accidentally disconnected.

In use, the LED array 16 may be detached from the adjustable strap 12 and used alone in a variety of ways. The connectors 22 may also allow the LED array 16 to be connected to other items, including other user equipment (e.g., backpack) and user body parts (e.g., arm or leg). In these alternate uses (not shown), the illuminating arc may be directed in other than a forward direction.

The LED array 16 is coupled to a power source 40, preferably a battery pack 18 via cord 20. As shown in FIG. 10, a power switch 42 is positioned within the cord 20. In the disclosed embodiment, the power switch 42 allows for “high,” “low” and “off” operation of the LED array 16. The battery pack 18 may also, or alternatively, have a power button or switch to adjust the power output of the LED array 16. As shown, the power cord 20 connects directly to the battery pack 18, which can be secured to the adjustable strap 12 in some manner. Preferably, an elastic pocket 44 is attached to the adjustable strap 12 to allow insertion of the battery pack 18 during use.

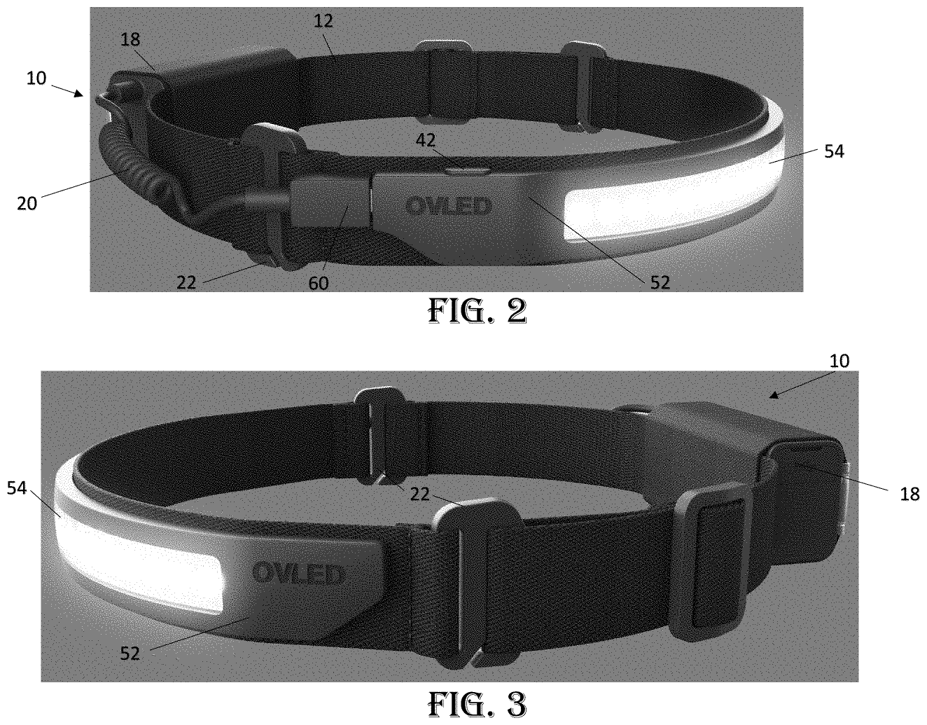

Returning to FIGS. 2, 3 and 11, a specific embodiment of the headlamp 10 is illustrated in which some alternate features are shown. For example, the battery pack 18, or any other power source, is detachably connected to the LED array 16 by a power input port 50. Further, as illustrated in FIG. 7, a front view of the embodiment of FIGS. 2 and 3, the LED array 16 is comprised of a plurality of linearly aligned LEDs 24 contained within a housing 52 and covered by a suitable protective lens 54. A power switch 42 is preferably positioned on the housing 52 to allow “one-touch” control of power to the LED array 16.

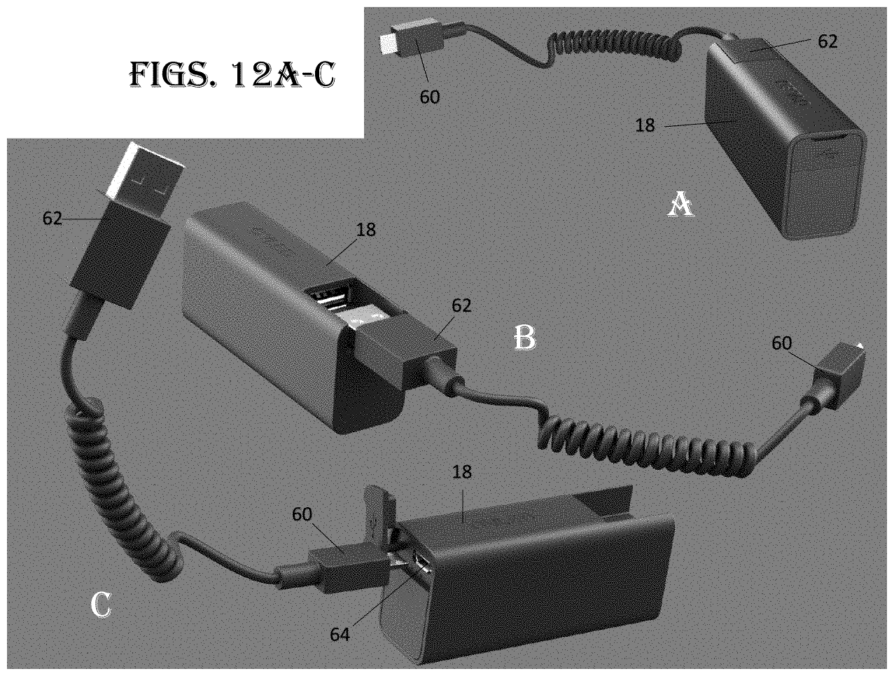

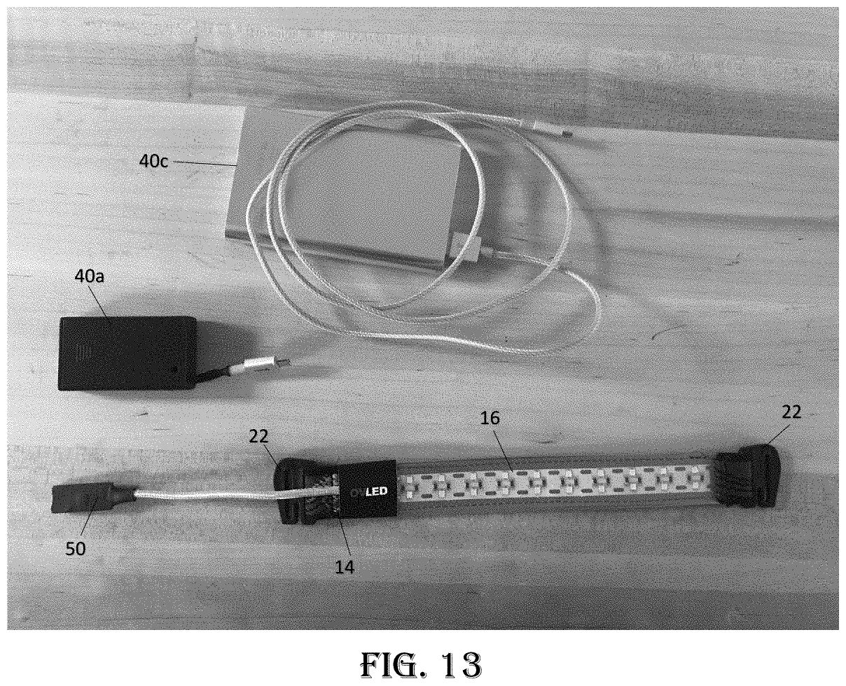

Referring to FIGS. 12 and 13, the battery pack 18 and the power cord 20 are further illustrated. In standard operation, one end of the power cord 20 plugs directly into the LED array 16 via a first connector 60 (FIG. 12A), while the opposite end of the power cord 20 plugs into the battery pack 18 via a second connector 62 (FIG. 12B). As the preferred battery pack 18 for this headlamp 10 is rechargeable, the power cord 20 also connects the battery pack 18 to a charging source (not shown) by plugging the first connector 60 of the power cord 20 into a charging port 64 of the battery pack 18 (FIG. 12C) and the second connector 62 into a charging source (not shown). The first connector 60 and the second connector 62 are preferably selected from the group of common connectors comprising a USB connector (type A or C), USB mini connector, USB micro connector, a lightning connector, or any other suitable power connector known by those skilled in the art. Preferably, the two connectors, 60 and 62, on the cord 20 are of two different types of connectors.

Referring now to FIGS. 13-16, in another embodiment the power input port 50 may extend from the LED array 16 to allow coupling to a multitude of different power sources 40 to power the LEDs 24. For example, the LED array 16 can be powered by a small battery pack 40A using AAA or AA batteries, a small portable charging stick 40B, a larger portable charging pack 40C, or an AC power cord 40D.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A wearable headlamp comprising:
an adjustable strap for securing to a desired user;
an LED array attached to the adjustable strap; and
a power source connected to the LED array;
wherein the LED array is configured to provide an illumination arc of not less than 120 degrees.

2. The wearable headlamp of claim 1, wherein the power source comprises a battery pack having three output levels.

3. The wearable headlamp of claim 1, wherein the illumination arc is at least 150 degrees.

4. The wearable headlamp of claim 3, wherein the illumination arc is about 210 degrees.

5. The wearable headlamp of claim 1, wherein the LED array comprises a range of from 4 to 30 LEDs.

6. The wearable headlamp of claim 5, wherein the number of LEDs, is in the range of from 8 to 20.

7. The wearable headlamp of claim 1, wherein the LED array has an output of at least 250 lumens.

8. The wearable headlamp of claim 7, wherein the LED array has an output of at least 280 lumens.

9. The wearable headlamp of claim 1, wherein the LED array comprises a universal port for connection to the power supply.

10. The wearable headlamp of claim 1, wherein the LED array is positioned within a housing having a protective lens for the LED array.

11. The wearable headlamp of claim 1, wherein the adjustable strap comprises a first adjustable portion and a second portion, the LED array being attached to the second portion

12. The wearable headlamp of claim 11, wherein the second portion of the adjustable strap comprises at least one connector for detachably connecting to the first adjustable portion.

13. The wearable headlamp of claim 1, wherein the power source is selected from the group consisting of a DC battery pack, a portable charger device, and an AC power cord.

14. A wearable headlamp comprising:
an adjustable strap for securing to a desired user;
an LED array comprised of from 8 to 30 LEDs and attached to the adjustable strap; and
a power source having at least three output levels and electrically connected to the LED array;
wherein the LED array is configured to provide an illumination arc of not less than 180 degrees.

15. The wearable headlamp of claim 14, wherein the illumination arc is about 210 degrees.

16. The wearable headlamp of claim 14, wherein the number of LEDs is in the range of from 8 to 20.

17. The wearable headlamp of claim 14, wherein the LED array has an output of at least 250 lumens.

18. The wearable headlamp of claim 17, wherein the LED array has an output of at least 280 lumens.

19. The wearable headlamp of claim 14, wherein the LED array comprises a universal port for connection to the power supply.

20. The wearable headlamp of claim 14, wherein the adjustable strap comprises a first adjustable portion and a second portion, the LED array being attached to the second portion

21. The wearable headlamp of claim 20, wherein the second portion of the adjustable strap comprises at least one connector for detachably connecting to the first adjustable portion.

22. The wearable headlamp of claim 14, wherein the power source is selected from the group consisting of a DC battery pack, a portable charger device, and an AC power cord.
